(19) United States
(12) Patent Application Publication
(10) Pub. No.: US 2009/0014240 A1
(43) Pub. Date: Jan. 15, 2009

(54) LADDER SUPPORT

(76) Inventor: David Roger Salisbury, Victoria (AU)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/064,141

(22) PCT Filed: Aug. 22, 2006
(86) PCT No.: PCT/AU2006/001208

§ 371 Date: May 19, 2008

(30) Foreign Application Priority Data
Aug. 22, 2005 (AU) 2005904545

(51) Int. Cl. E06C 7/48; E06C 1/34; E06C 1/04

(52) U.S. Cl. 182/107; 182/214; 182/129

(57) ABSTRACT

A ladder support (65) supports a ladder resting against guttering attached to a building. The support (65) is attached to the guttering by attachment means (31, 39) in a manner to prevent relative movement. A guide (32, 62) extends from the attachment means to a ladder stop (34, 64) adapted to capture a rail of a ladder to prevent substantial movement of the ladder. The ladder support system further includes a gutter bracket (50, 80) to transfer load from a ladder to a building structure.

### CROSS-REFERENCE TO RELATED APPLICATIONS

The present application claims priority from Australian Provisional Patent Application No 2005904545 filed on 22 Aug. 2005, the content of which is incorporated herein by reference.

### TECHNICAL FIELD

This invention relates to a ladder support and relates particularly to a support for a ladder resting against the guttering around a building to facilitate access to the guttering and/or building roof.

### BACKGROUND OF THE INVENTION

It is often necessary for a building owner or occupier, or a tradesman, to gain access to the roof of a building for repairs or maintenance, or equipment installation or the like. It is also necessary to gain access to the guttering for purposes of maintenance, painting, cleaning or the like. With many building structures, such access is difficult due to the nature of the ground where a ladder is to be used. The ground may be sloping or be relatively soft, or covered in a non-stable surface. In all instances where ladders are used to provide access to a relatively high position above the ground, it is most important that the ladder is properly supported. Many accidents occur due to ladders being improperly supported and moving due to the load on the ladder when a person climbs the ladder. Further, ladders, particularly relatively light ladders formed of aluminium, may be moved by the wind unless properly supported.

The use of ladders is a hazardous activity, and safety issues and liability issues for a building owner or occupier can arise if a ladder is improperly used. While scaffolding is relatively safer to use if properly installed and maintained, most homeowners and tradesmen use ladders to access roofs and guttering on an ad hoc basis where the use of scaffolding is unwarranted, unnecessary and inconvenient.

U.S. Pat. No. 5,215,163 describes a ladder bracket which bolts to the facia of a building in order to lean the ladder close to the roof line but clear of the gutter itself. The device requires bolts to pass through the facia. Tiles often project into the gutter. These must be lifted or removed to make the installation. In some gutters the free edge is somewhat higher than the fixed edge so that securing the bolts is difficult. If the bar against which the ladder leans is clear of the gutter it increases the distance between the person on the ladder and the parts of the building which may need attention such as the eaves.

It is therefore desirable to provide a ladder support which reduces the hazards associated with use of a ladder when accessing a building roof or guttering.

It is also desirable to provide a ladder support which is able to be secured in position to provide a permanent location for use of a ladder in accessing a building roof or the like.

It is also desirable to provide a ladder support which may be used with a wide variety of different gutter sections and structures.

It is also desirable to provide a ladder support which reduces the likelihood of a ladder moving laterally when in position and in use.

It is also desirable to provide a ladder support that is able to be used with a wide varieties of ladders of different constructions and dimensions.

It is also desirable to provide a ladder support which provides a firm, stable platform to receive the upper end of a leaning ladder.

It is also desirable to provide a ladder support that is relatively simple in construction and is easy to use.

It is also desirable to provide a ladder support that is able to be fixed in position to an existing gutter.

It is also desirable to provide a ladder support that is able to be moved from place to place along the length of guttering.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

In accordance with one aspect of the invention there is provided a ladder support adapted to support a ladder resting against guttering attached to a building, the support including an attachment means by which the support is attached to the guttering in a manner to prevent relative movement between the attachment means and the guttering, a guide extending from the attachment means, a ladder stop mounted on the guide and adapted to capture a rail of a ladder to prevent substantial movement thereof relative to the support.

In one form of the invention, the attachment means comprises a bracket having a plurality of pins extending therefrom. The pins are adapted to engage within cooperating holes formed in a top front edge of the guttering. With this arrangement, the bracket is mounted on the top front edge of the guttering with pins engaged in holes to prevent movement of the bracket along the guttering.

Preferably, the guide comprises an elongated member extending outwardly from a front edge of the attachment means when the support is in position.

In one embodiment, the ladder stop is moveable relative to the guide towards and away from the attachment means. In this form, the ladder stop may comprise a sleeve engaged on the guide and moveable there along. The sleeve carries a substantially L-shaped member which, in use, engages about a rail of a ladder thereby preventing relative movement between the guide and the ladder rail. A handle may be provided on the ladder stop to facilitate movement of the stop along the guide.

In another form, the ladder stop and guide are formed as a single, integral unit extending from the attachment means.

In another form of the invention, the attachment means comprises a clamp which engages around the rolled, upper edge of the guttering and has a rear clamping face to engage an inside surface of the front wall of the guttering. The clamp is secured in position using an outer clamp member attached by, for example, an over centre linkage, to the clamp body whereby the clamp is easily able to be engaged with and disengaged from the top front edge portion of guttering. The guide is attached to the clamp body in a manner similar to that described above.

With this embodiment, the ladder support may be used with existing guttering. It will be understood that embodiments of the invention may be designed to clamp to guttering of a wide variety of shapes and mounting arrangements.

According to another aspect of the invention there is provided a gutter and ladder support system comprising a gutter formed with an outer edge portion which has a reversely turned bead, the bead having a plurality of holes in an upper surface, the holes being substantially equally spaced along the length of the gutter, a ladder support adapted to support a ladder resting against the gutter when the ladder support is mounted to a building structure, the support including an attachment means by which the support is attached to the guttering in a manner to prevent relative movement between the attachment means and the guttering, the attachment means including a plurality of projections each of which is adapted to engage in one of the holes in the gutter bead, and a ladder stop mounted on the attachment means and adapted to capture a rail of a ladder to restrict movement thereof relative to the support.

Preferably, the system also includes a gutter bracket to mount the gutter to a building structure, the bracket having a rear plate adapted to be fixed to the building structure, a forwardly extending leg extending from an upper edge portion of the rear plate, and at least one finger on an outer end of the leg, the finger being adapted to engage within the gutter bead between adjacent holes.

In one form, two substantially parallel fingers are carried by the leg.

The forwardly extending leg of the gutter bracket preferably has a slot-defining portion aligned substantially parallel to the rear plate, the slot defining portion being spaced apart from the rear plate by a first distance sufficient to accommodate a gutter rear panel. For example the slot defining portion may be a rearward portion of the forwardly extending leg extending from the rear plate by the first distance and then extending, in use, in a downwards direction. In such embodiments, a load upon the forwardly extending leg, for example when loaded by a ladder against the gutter, is preferably transferred from the slot defining portion of the forwardly extending leg through the gutter panel in the slot to the rear plate behind the gutter panel.

The slot defining portion is preferably configured such that when the gutter rear panel is accommodated in the slot it is held against retraction or lateral movement, for example being held by friction and/or spring force. Such embodiments are particularly advantageous in resisting lateral forces upon the gutter caused for example by the ladder support.

### BRIEF DESCRIPTION OF THE DRAWINGS

In order that the invention is more readily understood, embodiments thereof will now be described with reference to the accompanying drawings:

FIG. 1 illustrates one form of guttering with which a ladder support in accordance with one embodiment of the invention may be used;

FIG. 2 is a perspective view of a ladder support in accordance with an embodiment of the invention;

FIG. 3 is an end elevational view of a ladder support of FIG. 2 mounted on a guttering of FIG. 1;

FIG. 4 is an end elevational view of a second embodiment of the invention,

FIG. 5 illustrates a further form of guttering with which a ladder support in accordance with embodiments of the invention may be used;

FIG. 6 is a perspective view of a ladder support in accordance with another embodiment of the invention,

FIGS. 7a and 7b are a perspective view and a side view, respectively, of a gutter support bracket for use with embodiments of the invention; and

FIGS. 8a and 8b are a perspective view and a top cross-sectional view, respectively, of another gutter support bracket for use with embodiments of the invention.

### DESCRIPTION OF THE PREFERRED EMBODIMENTS

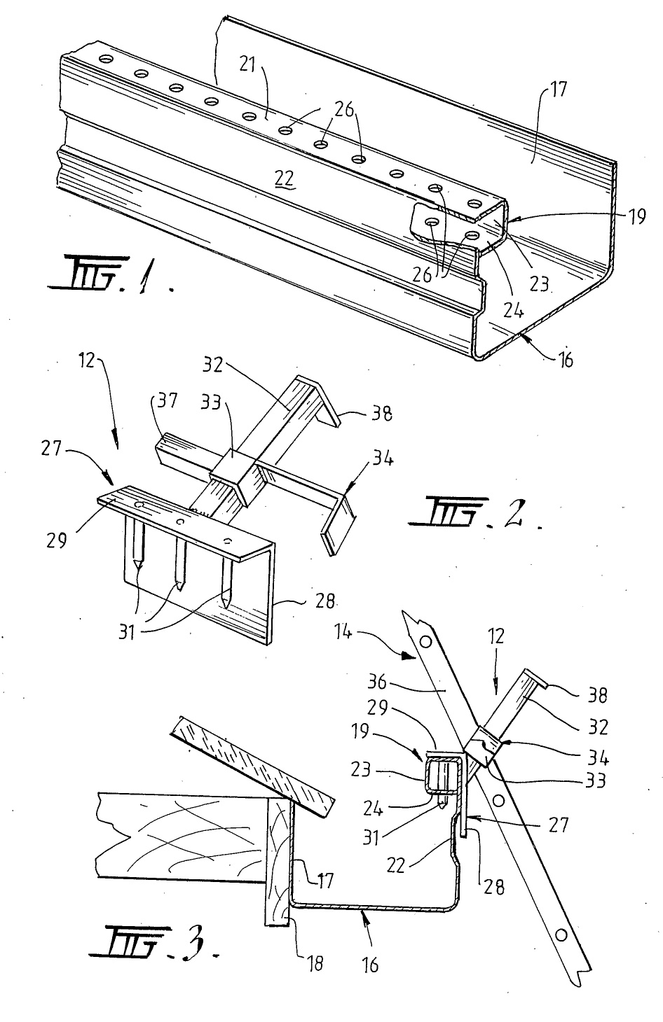

Referring to FIGS. 1 to 3 of the drawings, a ladder support 12 of this embodiment is adapted to support a ladder 14 resting against the upper, outer edge of a section of guttering 16, a rear wall 17 of which is secured to and supported by a facia 18, as by nails, support brackets or the like as is known in the art.

The guttering 16, designed to be used with this embodiment of ladder support 12, is formed with an upper edge portion 19 which has a substantially flat, horizontal upper surface 21 extending rearwardly from the front face 22. An inner edge surface 23 extends downwardly from the upper surface 21 and a lower reversely turned edge 24 extends towards the front surface 22.

A plurality of holes 26 are formed in both the upper surface 21 and lower edge 24 and extend along the length of the guttering 16. The ladder support of this embodiment comprises a bracket 27 having a front wall 28 and a top wall 29 which is adapted, in use, to engage with the upper surface 21 of the guttering 16. A plurality of downwardly extending pins 31 are fixed to the top wall 29 and, in use, are adapted to pass through selected adjacent holes 26 in the upper surface 21 and lower edge 24 of the guttering upper edge portion 19. The engagement of the pins 31 with the upper edge portion 19 is shown more particular in FIG. 3.

The bracket 27 has an upwardly and outwardly extending guide 32 on which is mounted a sleeve 33 to which is attached a ladder stop 34. The sleeve 33 is moveable along the guide 32 so as to move the ladder stop 34 towards and away from the bracket 27. The ladder stop 34 is L-shaped and is adapted to engage over and restrict relative movement of a rail 36 of a ladder 14 resting against the guttering 16.

In use, a ladder will be engaged against the guttering 16, and the ladder support is engaged with the upper edge portion 19 of the guttering 16 with the sleeve 33 moved away from the bracket 27 to the upper end of the guide 32 so that the guide is able to be engaged against the inner surface of the ladder rail 36 to be captured by the stop 34. With the support in position, the sleeve 34 is allowed to move along the guide 32 towards the bracket 27 whereby the L-shaped ladder stop 34 engages over the rail 36 thereby preventing relative lateral movement of the ladder 14. The ladder may then be used in safety without risk of the ladder being dislodged from its stable position against the guttering 16.

A handle 37 may be provided on the guide 32 to assist movement thereof.

It will be appreciated that any number of pins 31 may be provided extending downwardly from the top wall 29. Preferably, two or more pins are provided to provide desired stability.

The pins may be of a length to engage only through holes 26 in the upper surface 21. This arrangement would avoid the need to provide additional holes in the lower edge 24.

The guide 32 is preferably of rectangular or square section, or other non-circular section, to prevent relative rotation of the sleeve 33 thereon. A lug or other means may be provided on the upper end of the guide 32 to prevent the sleeve 33 being removed therefrom in use.

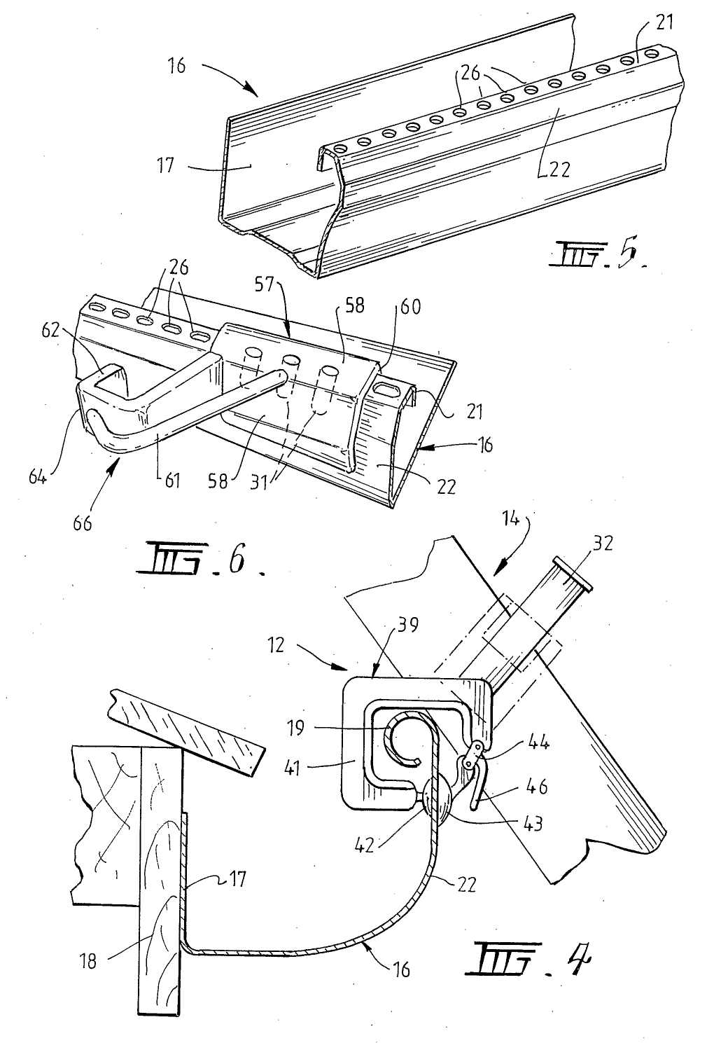

Referring to FIG. 4, a second embodiment is illustrated, in this embodiment, a clamp 39 is adapted to engage the upper outer edge portion 19 of the guttering 16. The clamp 39 includes a clamp body 41 of substantially C-shape with a pivotal foot at an inner end which is adapted to engage the rear surface of the front wall 22 of the guttering 16. The pivotal foot 42 allows for minor misalignment and differing angles of the guttering front wall 22.

At the other end of the clamp body 41, an outer clamp member 43 is pivotally attached by an over centre lever 44 carrying a handle 46.

A guide 32 extends outwardly from the clamp body 41 in a similar manner to that described with reference to the previous embodiment. Similarly, the sleeve 33 and ladder stop 34 are moveable along the guide 32 as previously described. In use, the clamp body 41 is placed over the upper edge portion 19 of the guttering 16 so that the pivotal foot 42 engages the rear surface of the front wall 22. The outer clamp member 43 is held away from the foot 42 to provide the maximum opening to facilitate the engagement. The outer clamp member 43 is then engaged with the outer surface of the front wall 22 and the over centre linkage 44 is moved by the handle 46 to lock the outer clamp member 43 against the guttering 16. By insuring appropriate linkage and lever dimensions, a substantial clamping force is able to be generated to secure the clamp body 41 to the guttering 16. The ladder stop 34 is actuated in the manner previously described so that the stop 34 engages a ladder rail 36 to prevent lateral movement thereof relative to the guttering 16.

It will be appreciated that other forms of clamp may be used to clamp the guide and ladder stop 34 in a position whereby the stop is able to engage with the ladder rail 36 to prevent relative movement.

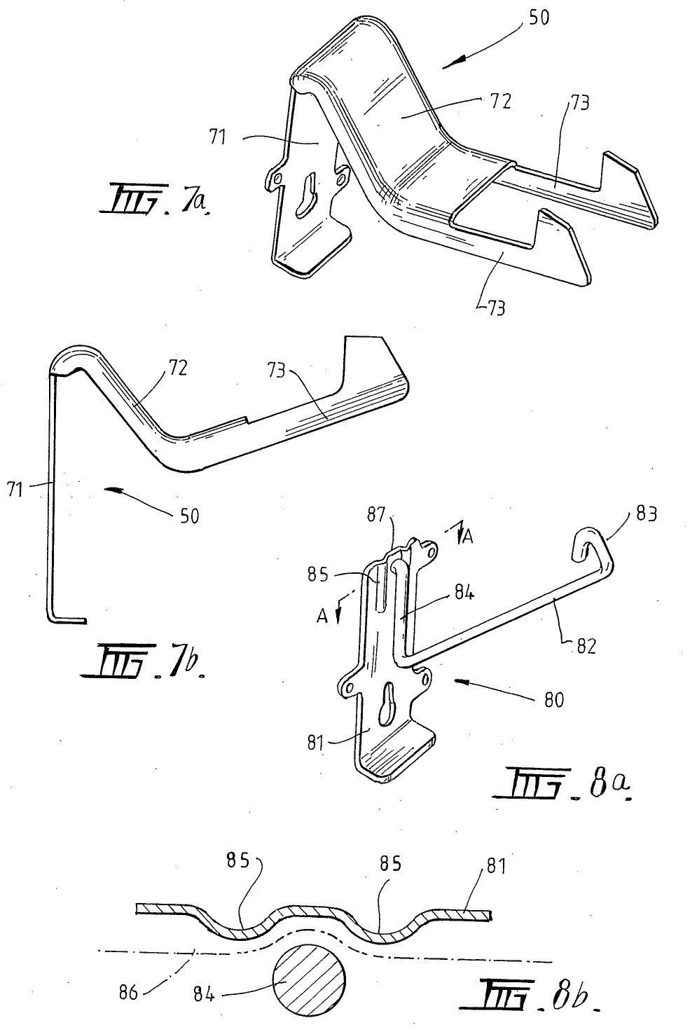

Referring to FIGS. 5 to 7, a ladder support 12 of this embodiment is adapted to support a ladder 14 resting against the upper, outer edge of a section of guttering 16 which is secured to and supported by a bracket 50 (FIG. 7) fastened to a facia 18 or the like, as by nails, screws or the like as is known in the art.

The guttering 16 designed to be used with this embodiment is similar to that of FIG. 1, and is similarly formed with an upper edge portion 19 which has a substantially flat, horizontal upper surface 21 extending rearwardly from the front face 22. An inner edge surface 23 extends downwardly from the upper surface 21.

A plurality of holes 26 are formed in the upper surface 21 and extend along the length of the guttering 16. The holes are preferably elongated in the direction of the gutter 16.

The ladder support of this embodiment comprises a bracket 57 having a front wall 58, of a shape to closely engage the front surface 22 of the gutter 16, a top wall 59 which is adapted, in use, to engage with the upper surface 21 of the guttering 16, and a rear wall 60 to engage behind the inner edge surface. A plurality of downwardly extending pins 31 are fixed to the top wall 59 and, in use, are adapted to pass through selected adjacent holes 26 in the upper surface 21 of the guttering upper edge portion 19 in a manner similar to that of FIG. 3.

The ladder support 65 has a ladder stop 64 extending from the support bracket 57. The ladder stop 64 includes a J-shaped arm 62 with a reinforcing handle 61. The arm 62 is adapted to engage over and restrict relative movement of a rail 36 of a ladder 14 resting against the guttering 16 when the pins 31 are engaged through holes 26 to restrict lateral movement of the support bracket 57 relative to the gutter 16.

The gutter system of this embodiment also includes the gutter bracket 50 (FIG. 7) to mount the gutter 16 to a building facia or other structure (not shown), the bracket 50 having a rear plate 71 adapted to be fixed to the building structure, a forwardly extending leg 72 extending from an upper edge portion of the rear plate 71, and at least one, preferably two substantially parallel fingers 73 on an outer end of the leg 72, the fingers 73 being adapted to engage within the gutter bead defined by the top portion of the front face 22, the top face 21 and the rear wall 60. The fingers 73 are spaced apart so as to lie between adjacent holes 26.

FIG. 8 illustrates another gutter bracket 80 to mount the gutter 16 to a building facia or other structure (not shown). The bracket 80 has a rear plate 81 adapted to be fixed to the building structure, and a forwardly extending leg 82 extending from an upper edge portion of the rear plate 81. An outer end 83 of the leg 82 is adapted to engage within the gutter bead defined by the top portion of the front face 22, the top face 21 and the rear wall 60. Portion 84 of leg 82 defines a slot between itself and the rear plate 81. Rear plate 81 has protrusions 85 on either side of the portion 84.

FIG. 8b is a top cross sectional view across line A-A in FIG. 8a. FIG. 8b illustrates the slot defined between rear plate 81, protrusions 85, and slot-defining portion 84. Dotted line 86 illustrates the slight deformation of a gutter rear panel caused by the configuration of the slot when the gutter is inserted into the slot. This deformation, together with the spring behaviour of the portion 84 relative to the rear plate 81, serves to hold the gutter rear panel snugly in the slot. This is advantageous in preventing lateral movement of the gutter, for example when the gutter is subjected to a lateral load from a ladder and accompanying ladder support.

The arrangement of FIGS. 8a and 8b is further advantageous in that a rearward force applied to end portion 83, for example when a ladder is leaned against the gutter, is transferred effectively to the rear plate 81. This is because the portion 84 is snug against the rear panel of the gutter which in turn is snug against the rear panel and/or protrusions 85. Thus it is not necessary for all such rearward force to be transmitted via the joint 87.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A ladder support adapted to support a ladder resting against guttering attached to a building, the support comprising an attachment means by which the support is attached to the guttering in a manner to prevent relative movement between the attachment means and the guttering, a guide extending from the attachment means, a ladder stop mounted on the guide and adapted to capture a rail of a ladder to prevent substantial movement thereof relative to the support.

2. The ladder support according to claim 1, wherein the attachment means comprises a bracket having a plurality of pins extending therefrom.

3. The ladder support according to claim 2 wherein the pins are adapted to engage within cooperating holes formed in a top front edge of the guttering, such that the bracket can be mounted on the top front edge of the guttering with pins engaged in holes to prevent movement of the bracket along the guttering.

4. The ladder support according to claim 1, wherein the attachment means comprises a clamp which engages around the rolled, upper edge of the guttering and has a rear clamping face to engage an inside surface of the front wall of the guttering.

5. The ladder support according to claim 4, wherein the clamp is secured in position using an outer clamp member attached by an over centre linkage to the clamp body whereby the clamp is easily able to be engaged with and disengaged from the top front edge portion of guttering.

6. The ladder support according to claim 1 wherein the guide comprises an elongated member extending outwardly from a front edge of the attachment means when the support is in position.

7. The ladder support according to claim 1 wherein the ladder stop is moveable relative to the guide towards and away from the attachment means.

8. The ladder support according to claim 7 wherein the ladder stop comprises a sleeve engaged on the guide and moveable there along.

9. The ladder support according to claim 8 wherein the sleeve carries a substantially L-shaped member which, in use, engages about a rail of a ladder thereby preventing relative movement between the guide and the ladder rail.

10. The ladder support according to claim 9 wherein a handle is provided on the ladder stop to facilitate movement of the stop along the guide.

11. The ladder support according to claim 1 wherein the ladder stop and guide are formed as a single, integral unit extending from the attachment means.

12. A gutter and ladder support system comprising a gutter formed with an outer edge portion which has a reversely turned bead, the bead having a plurality of holes in an upper surface, the holes being substantially equally spaced along the length of the gutter, a ladder support adapted to support a ladder resting against the gutter when the ladder support is mounted to a building structure, the support including an attachment means by which the support is attached to the guttering in a manner to prevent relative movement between the attachment means and the guttering, the attachment means including a plurality of projections each of which is adapted to engage in one of the holes in the gutter bead, and a ladder stop mounted on the attachment means and adapted to capture a rail of a ladder to restrict movement thereof relative to the support.

13. The system of claim 12 further comprising a gutter bracket to mount the gutter to a building structure, the bracket having a rear plate adapted to be fixed to the building structure, a forwardly extending leg extending from an upper edge portion of the rear plate, and an outer end of the leg being

14. The system of claim 13 wherein the outer end of the leg comprises at least one finger adapted to engage within the gutter bead between adjacent holes.

15. The system of claim 14 wherein two substantially parallel fingers are carried by the leg.

16. The system of claim 12 wherein the forwardly extending leg of the gutter bracket has a slot-defining portion aligned substantially parallel to the rear plate, the slot defining portion being spaced apart from the rear plate by a first distance sufficient to accommodate a gutter rear panel.

17. The system of claim 16 wherein the slot defining portion is a rearward portion of the forwardly extending leg, extending from the rear plate by the first distance and then extending, in use, in a downwards direction.

18. The system of claim 16 wherein the slot defining portion is configured such that when the gutter rear panel is accommodated in the slot it is held against retraction or lateral movement.
